(19) United States
(12) Patent Application Publication
(10) Pub. No.: US 2006/0266576 A1
(43) Pub. Date: Nov. 30, 2006

(54) Vehicle, in particular convoy security vehicle, with means for clearing mines

(75) Inventor: Detlev Eckhoff, Martensrade (DE)

Correspondence Address: GRIFFIN & SZIPL, PC, SUITE PH-1, 2300 NINTH STREET, SOUTH, ARLINGTON, VA, 22204, US

(73) Assignee: Rheinmetall Landsysteme Gmbh, Kiel (DE)

(21) Appl. No.: 11/345,398

(22) Filed: Feb. 2, 2006

Related U.S. Application Data
(60) Provisional application No. 60/648,699, filed on Feb. 2, 2005.

(30) Foreign Application Priority Data
Feb. 2, 2005 (DE) 10 2005 004 913.3

(51) Int. Cl. G07F 11/16

(52) U.S. Cl. 180/900; 221/231

(57) ABSTRACT

The invention is an easily maneuverable vehicle that can travel in a convoy at full speed, but also fulfills the task of mine-clearing at the site. To this end, a conventional carrier vehicle, for example a truck crane chassis, is provided with at least one front module and at least one rear module that are tilted or folded up when in the driving position. In the working position, i.e., in the triggering mode, the entire weight of the vehicle is then used to generate the ground pressure. For this purpose the vehicle is raised via the modules so that the dead weight of the carrier vehicle is displaced onto the modules for clearing, and is conducted by the modules over the area to be cleared.

This application claims priority from U.S. Patent Application No. 60/648,699, filed Feb. 2, 2005, and from German Patent Application 10 2005 004 913.3, filed Feb. 2, 2005, the entire disclosures of which are incorporated herein by reference.

### FIELD OF THE INVENTION

This invention relates to the clearing of land mines and a vehicle for such clearing.

### BACKGROUND OF THE INVENTION

As a result of the new military combat zones, personnel- and materiel protection for security forces in crisis areas is of decisive importance. Especially the protection of convoys but also the installation of temporary camps in foreign zones always presents a high risk relating to the presence of mines, in particular land mines.

Conventional mine-clearing systems have means at the front and/or back by which mines on the surface or lying hidden are triggered. Devices of this type are described for example in DE 197 02 297 C1, DE 198 13 541 C1, DE 199 42 030 A1, DE 199 42 020 A1, EP 0 929 789 B1, EP 0 991 908 B1, and AT 407 572 B.

On the Internet website http://www.defense-update.com/events/2004/summary/eurosatory04-engineering.h tm, a SOUVIM mine-clearing vehicle made by the MBDA company is described. The system concept comprises two vehicles with a total of three trailers for the specific triggering of pressure-sensitive mines and besides the vehicle(s) additionally features several special wheels at the front and back. The design and mode of operation of these wheels are disclosed in EP 1 429 106 A1. The four wheels on both sides of a wheel axle serve to overcome obstacles as well as to trigger the mines. When one of the wheel pairs strikes an obstacle, the next wheel pair is brought into position and neutralizes the mines by the dead weight of the wheel construction. Such a vehicle has a low traveling speed. In addition, its maneuverability is limited due to the complex wheel construction.

In addition to the fact that the traveling speed of this vehicle approximately corresponds to the clearing speed and is approx. 20 km/h, which reduces the overall mobility of the troops, these vehicles, also known as heavy decoy vehicles (cf. http://www.rheinmetall-detec.com/index.php?lang=2&fid=949) have the further disadvantage that their wheel construction is itself complex and therefore very heavy. Easy maneuverability of the total vehicle is likewise not provided.

It is likewise disadvantageous that many of the known solutions are based on cutting or striking systems that result in a plastic deformation of the surface and thus sharply reduce negotiability for following vehicles.

### SUMMARY OF THE INVENTION

The object of the invention is to set forth a vehicle with a clearing system that produces a high ground pressure and thus ensures that all known types of vehicle can negotiate the cleared area safely, and in addition is suitable as a convoy safeguard.

The invention is fundamentally based on the concept of creating an easily maneuverable vehicle that can travel in the convoy at full speed, but also fulfills the task of mine-clearing at the site. To this end it is proposed that preferably a conventional carrier vehicle, for example a truck crane chassis, be provided with at least one front module and at least one rear module that are tilted or folded up when in the driving position. Thus the speed of the carrier vehicle itself can be utilized to bring it into the area of the mines. In the working position, i.e. in the triggering mode, the entire weight of the vehicle may be used to generate the ground pressure. For this purpose the vehicle is raised via the modules so that the dead weight of the carrier vehicle is displaced onto the modules for the clearing, and is conducted over the area to be cleared by means of the modules. The ground contact surface is minimized by a special track- or wheel mechanism (module) while the mobility is maintained, in order to generate the greatest possible ground pressure with the smallest possible total weight of the vehicle. The modules themselves can have a lighter construction than conventionally known modules.

In a preferred embodiment the vehicle has two independent traveling drives for the two modes (working mode, transport mode). One of the traveling drives serves thereby for the rapid transport journey, and the other to drive the triggering modules (front and rear modules).

In a further development of the invention, the vehicle concept has a continuously adjustable working width, which is achieved by the steering units of the triggering modules arranged in the front and rear area. The front and rear modules are displaced thereby parallel to one another and thus can be operated from the working width of one module to the working width of both modules next to one another in the so-called “crab steer” mode. This working width can be broadened by further front and/or rear modules, whereby the modules can be mounted staggered with respect to one another either on the vehicle or on the previous module.

As already explained, self-contained drives are preferably provided in the triggering modules that drive, for example, tracks or wheels of the modules. Unlike conventional track mechanisms, in a further development of the invention the ground contact of this track drive is not on the running surface of the track, but only on its steering rollers. This increases the ground pressure by reducing the contact surface, while maintaining the climbing ability of track mechanisms.

The principal advantage of the present invention is that the mobility of the vehicle for the mine clearing is increased by reducing the dead weight of the entire vehicle, and thus this vehicle is also suitable as a convoy security vehicle. Moreover, mine clearing is possible forwards as well as backwards. The vehicle itself maintains its good mobility and maneuverability, even in the case of damage to the triggering modules. Both the damaged module and the undamaged module are raised by the base vehicle, so that the vehicle can remove itself to a safe place independently.

When the vehicle is in position, steering can be performed in both the transport- and the triggering-mode. The vehicle has a relatively small steering radius, whereby front and/or rear steering are possible.

The described vehicle excels in its versatile range of applications, has low total weight and high-total mobility, has a high transport- and working-speed, and has large percentages of shared components.

The invention is explained in more detail on the basis of exemplary embodiments with drawings.

### BRIEF DESCRIPTION OF THE DRAWINGS

The drawings show the following:

FIG. 1 in a side view, a vehicle in drive position with raised track mechanisms,

FIG. 2 in a side view, the vehicle in the triggering mode with lowered track mechanisms as triggering modules,

FIG. 3 in a perspective representation, the track mechanism from FIG. 1,

FIG. 4 in a side view, the vehicle in drive position with raised wheel mechanisms,

FIG. 5 in a side view, the vehicle in the triggering mode with lowered wheel mechanisms as triggering modules,

FIG. 6 in a perspective representation, the wheel mechanism from FIG. 4,

FIG. 7 a top view of the vehicle,

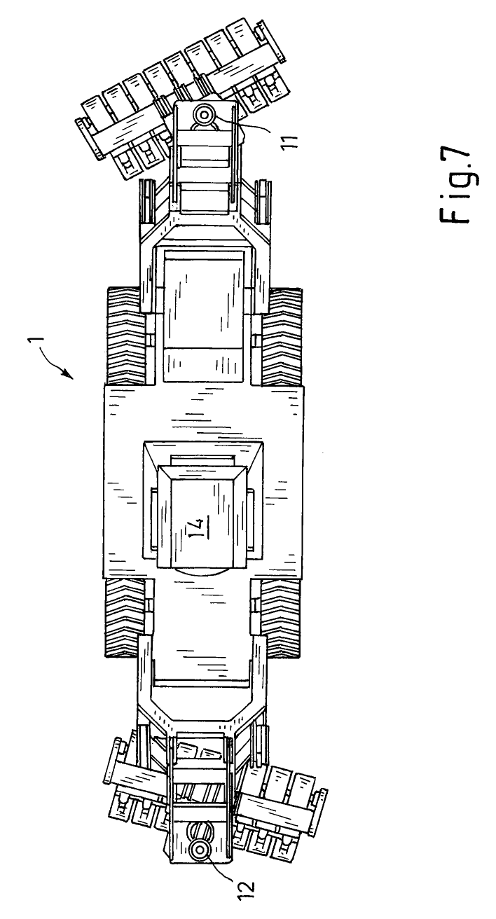

FIG. 8 a representation of the curve travel in a top view of the vehicle,

FIG. 9 a representation of the broadened triggering position.

### DETAILED DESCRIPTION OF THE PREFERRED EMBODIMENTS

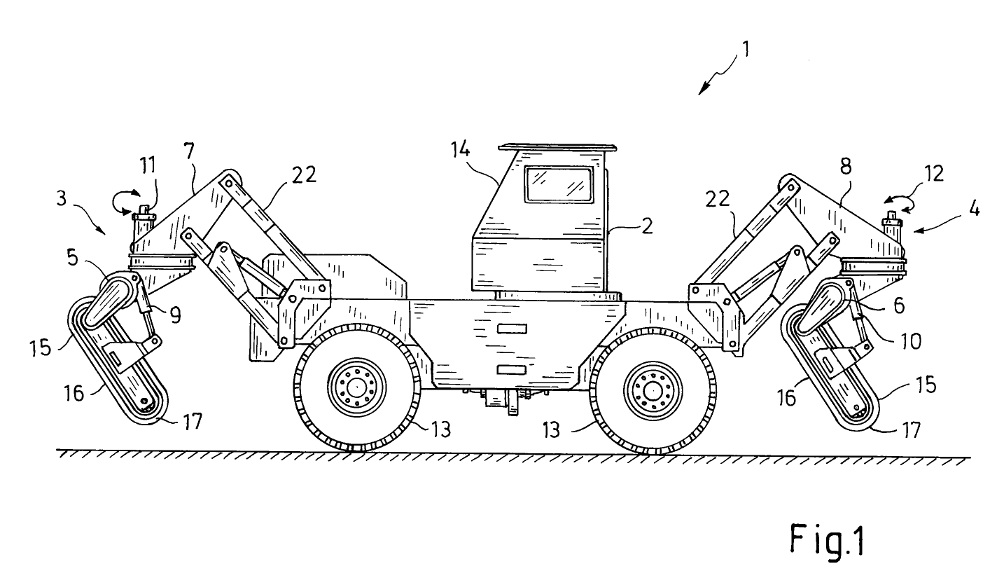

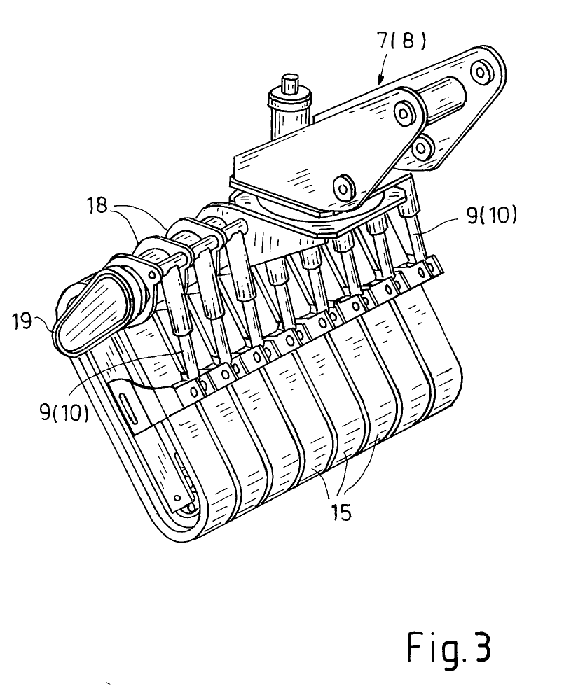

In a first exemplary embodiment according to FIG. 1, 1 denotes a vehicle in the transport position, composed here of a carrier or base vehicle 2 to whose front and rear are fixed at least one triggering module 3, 4. Both modules 3, 4 are preferably based in a first variant on several narrow track mechanisms 15 arranged next to one another (see also FIG. 3). Modules 3, 4 have self-contained drives in the base frame 5, 6, and are respectively connected to the base vehicle 2 via a swivel/lift mechanism 22 and swivel frames 7, 8. The task of these mechanisms is on the one hand to steer the modules 3, 4 in the working mode and on the other hand to implement the working width displacement (to be explained below).

For improved adjustment to the ground contour, each track mechanism 15 has a separate suspension 18 as well as a spring and damping unit 9, 10.

Preferably two hydraulic traveling drives (not shown in more detail) are provided as self-contained drives for each module 3, 4.

A torsionally stiff four-wheel-drive vehicle chassis can be the basis of the fundamental or base vehicle 2. The fundamental vehicle 2 includes the main frame of the clearing apparatus, the drive train for the preferably conventional traveling drive in the transport mode, the power supply for the traveling drives and steering units 11, 12 of the triggering modules 3, 4. The base vehicle 2 also preferably includes a steerable all-wheel-drive mechanism 13 and for example an operator cab 14, which can be omitted in remote-controlled vehicles.

The two triggering modules 3, 4 arranged in the front and rear area of the base vehicle 2 are based, as already explained, preferably but not necessarily, on track mechanisms 15 arranged next to one another (FIG. 3) whose ground contact, unlike conventional track mechanisms, is not on the running surface 16 but only on steering rollers 17. This increases the ground pressure by reducing the contact surface, while maintaining the climbing ability of track mechanisms. In a preferred embodiment, each of the two drive motors drives half the number of track mechanisms of one of the triggering modules 3, 4, in order thus to enable a differential compensation between the inside and outside curve track mechanisms 15. The power transmission can in principle be carried out via roller chains 19.

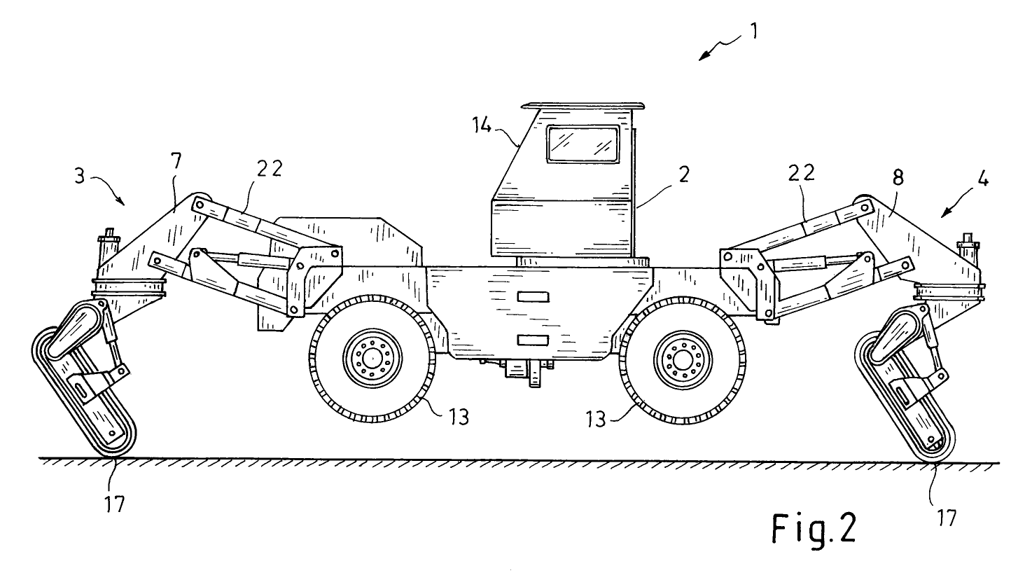

FIG. 2 shows the vehicle 1 in the working- or triggering position. The modules 3, 4 are hereby lowered via the swivel mechanisms 7, 8 until they raise the base vehicle 2 (will be explained below).

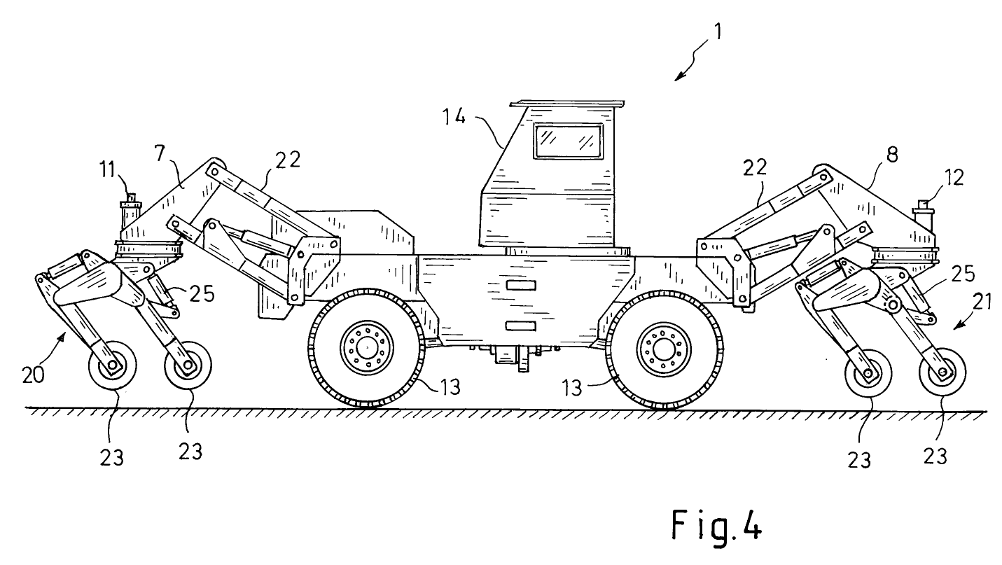

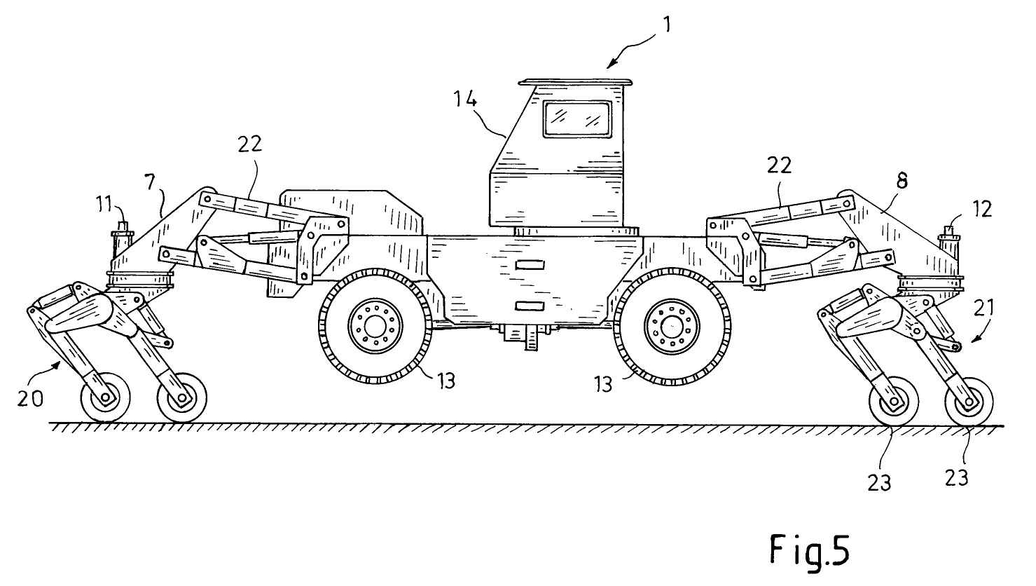

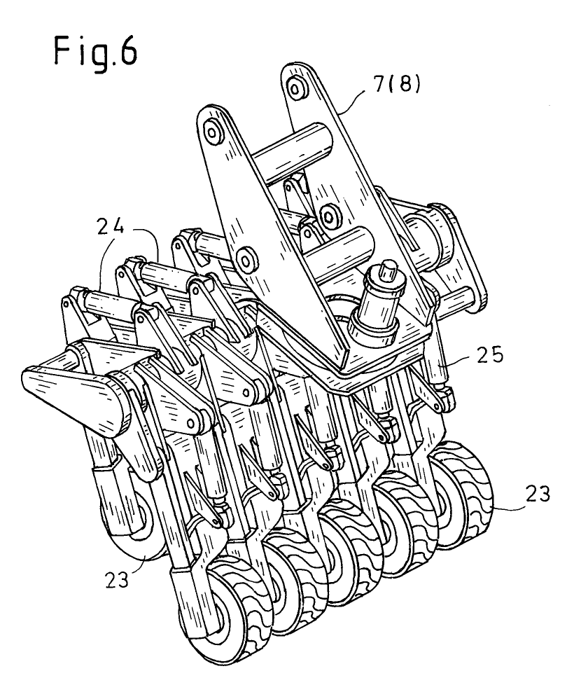

Alternatively to a module 3, 4 comprising track mechanisms 15, modules 20, 21 based on wheels 23 can also be constructed and used (FIG. 4, FIG. 5). The wheels 23 are preferably provided with individual wheel suspensions 24 thereby and arranged next to one another in two rows one behind the other respectively staggered (FIG. 6). The individual wheel suspensions 24 are made from a steering knuckle and have a separate bearing to the frame 7, 8 of the triggering unit 20, 21. Here too, each of the individual wheel suspensions 24 is provided with a spring- and damping unit 25. The drive of the individual wheels 23, comparable to the concept with track mechanisms 15, is carried out via two motors housed in the frame and a power transmission, e.g. via roller chain drives 19 to the individual wheels 23.

A predetermined breaking point in the form of a flange with a rapid-mount connection is housed inside the steering knuckle. The predetermined breaking point is the cutting site for the exchangeable components after a mine detonation.

The mechanical connection of the two triggering modules 3, 4 or 20, 21 to the base vehicle 2 is carried out via the parallelogram-type raising or lifting device 22. This has the task of raising the triggering modules 3, 4 or 20, 21 for the transport mode or lifting the base vehicle 2 onto them in the triggering mode.

In the transport mode, both triggering modules 3, 4 or 20, 21 are raised. The traveling drive and steering of the vehicle 1 are carried out via the base vehicle 2.

In the triggering mode the base vehicle 2 is raised by the at least two triggering modules 3, 4 or 20, 21. The traveling drive and steering are carried out via the triggering modules 3, 4 or 20, 21. The steering units 11, 12, here a hinged joint embodied as a bolster or hinge, enables a vertical swiveling or steering of the triggering modules 3, 4 or 20, 21 with respect to the base vehicle 2.

The protection against mines provided by the triggering modules 3, 4 or 20, 21 in various protection classes is embodied by means of the different predetermined breaking points provided (not shown in more detail). If the damage to a triggering module 3, 4 or 20, 21 is severe, the entire triggering module 3, 4 or 20, 21 can be exchanged via the rapid-change apparatus, not shown in more detail. These can also be used for air or rail transport as well as transport on trucks, in order to be able to uncouple the front and rear module 3, 4 or 20, 21 from the base vehicle 2 and thus to obtain lighter and smaller transport modules.

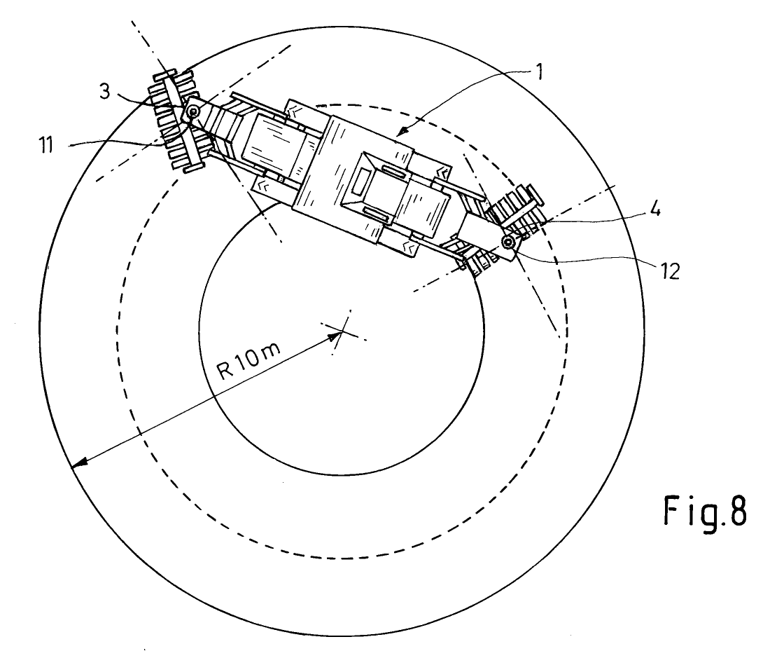

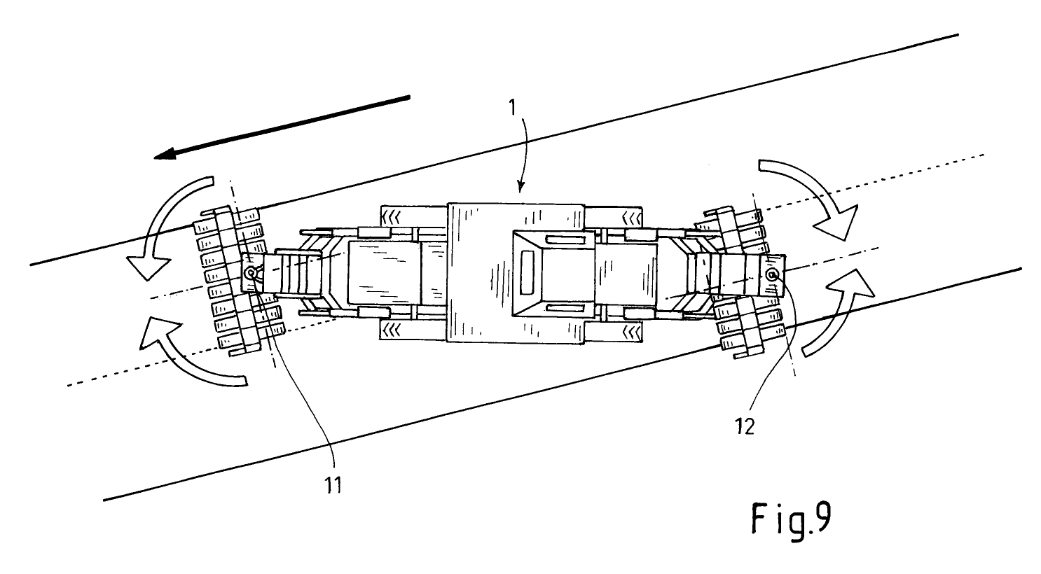

A continuously adjustable working width displacement also during the triggering mode is carried out through the steering units of the triggering modules 3, 4 or 20, 21 arranged in the front and rear area. Both modules 3, 4 or 20, 21 are displaced thereby parallel to one another (FIG. 9). The maximum working width is then provided from the width of the two modules 3, 4 or 20, 21 together. A steering control unit ensures a track connection between the front- and back module 3, 4 or 20, 21 as a function of the working width and a preset curve radius (FIG. 8).

On road surfaces with a low load-bearing capacity, the possibility exists of reducing the ground pressure of the triggering modules 3, 4 or 20, 21, in that a part of the weight is transferred to the traveling mechanism of the base vehicle 2. A control system on the lift apparatus ensures thereby that an adequately high weight remains on the triggering modules 3, 4 or 20, 21.

Of course, the vehicle 1 can be equipped additionally with further details needed to trigger other mines, such as for example intelligent mines (e.g. infrared or magnetic mines). Moreover detection, verification, and clearing components such as for example GPR-, TNA-sensors or manipulators can be integrated into the vehicle 1, in order to enable a specific verification or clearing on exposed positions such as bridges or houses. As the carrier vehicle, a tracked vehicle can equally well be used in place of a wheeled vehicle.

The arrangement of the triggering modules shown in the exemplary embodiments directly in the front area and in the rear area also include a lateral mounting of the modules on the carrier vehicle, if this arrangement enables a raising of the carrier vehicle. Then two modules that can be fixed laterally at the front and two modules that can be fixed laterally at the rear must be provided respectively thereby.

The chief task of the vehicle 1 described here is to trigger mines that are still present. Of course, this vehicle can be used with the same construction for other purposes as well. It is conceivable to use this vehicle off-road, to overcome almost impassable terrain, without the task of triggering mines.

While the present invention has been described with reference to certain preferred embodiments, one of ordinary skill in the art will recognize that additions, deletions, substitutions, modifications and improvements can be made while remaining within the spirit and scope of the present invention as defined by the appended claims.

While the present invention has been described with reference to certain illustrative embodiments, one of ordinary skill in the art will recognize, that additions, deletions, substitutions and improvements can be made while remaining within the scope and spirit of the invention as defined by the appended claims.

### LIST OF REFERENCE NUMBERS

1 Vehicle
2 Base vehicle
3 Module—front module
4 Module—rear module
5 Base frame
6 Base frame
7 Swivel frame
8 Swivel frame
9 Damping means
10 Damping means
11 Steering unit
12 Steering unit
13 All-wheel drive mechanism
14 Operator cab
15 Track mechanism
16 Running surface
17 Steering rollers
18 Individual suspension
19 Roller chains
20 Module—front module
21 Module—rear module
22 Lifting device
23 Wheels
24 Individual wheel suspension
25 Spring- and damping means

What is claimed is:

1. A vehicle having a front and a rear, comprising
a base vehicle; and
modules for traveling,
wherein the modules are disposed at the front and rear of the vehicle and can swivel to adjust their height with respect to the base vehicle, and the vehicle being raisable with the aid of the modules and, in this raised position, the vehicle being movable by means of the modules.

2. A vehicle according to claim 1, wherein said modules are disposed to clear or trigger mines.

3. A vehicle according to claim 1, wherein said base vehicle comprises a torsionally stiff four-wheel-drive vehicle chassis.

4. A vehicle according to claim 1, wherein said base vehicle comprises a torsionally stiff tracked vehicle chassis.

5. A vehicle according to claim 1, wherein said modules comprise self-contained drives and said modules are connected to said base vehicle via a swivel/lift mechanism and swivel frames.

6. A vehicle according to claim 1, further comprising steering units disposed to allow a vertical swiveling or steering of said modules with respect to said base vehicle.

7. A vehicle according to claim 6, characterized in that steering units are embodied as hydraulic units.

8. A vehicle according to claim 1, characterized in that the modules comprise predetermined breaking points in various protection classes.

9. A vehicle according to claim 1, characterized in that an entire said module can be exchanged via a rapid-change apparatus.

10. A vehicle according to claim 1, operable with a continuously adjustable working width displacement in a the triggering mode, whereby said modules disposed at the front and rear area are displaced parallel to one another by means of steering units.

11. A vehicle according to claim 1, wherein said modules comprise a plurality of track mechanisms disposed next to one another.

12. A vehicle according to claim 11, characterized in that a ground contact of said track mechanisms is on steering rollers.

13. A vehicle according to claim 11, wherein each said track mechanism comprises a separate suspension and a spring- and damping unit.

14. A vehicle according to claim 1, wherein said modules comprise wheels.

15. A vehicle according to claim 14, wherein said modules further comprise individual wheel suspensions, and said wheels are disposed next to one another in two rows, one behind the other respectively staggered.

16. A vehicle according to claim 15, wherein each said individual wheel suspension comprises a steering knuckle and a separate bearing to a frame of said modules, and a spring- and damping unit.
